(19) United States
(12) Patent Application Publication
(10) Pub. No.: US 2026/0252349 A1
(43) Pub. Date: Aug. 27, 2026

(54) ARTIFICIAL INTELLIGENCE-DRIVEN SOFTWARE DEVELOPMENT LIFECYCLE

(71) Applicant: ACCENTURE GLOBAL SOLUTIONS LIMITED, Dublin 4 (IE)

(72) Inventors: James Robert PRIESTAS, Alexandria, VA (US); Tara Lynn O'GARA, Chicago, IL (US); Sarat GURRAM, Chennai (IN)

(73) Assignee: ACCENTURE GLOBAL SOLUTIONS LIMITED, Dublin 4 (IE)

(21) Appl. No.: 19/061,454

(22) Filed: Feb. 24, 2025

(51) Int. Cl. G06F 8/77; G06F 8/20

(52) U.S. Cl. CPC G06F 8/77; G06F 8/20

(57) ABSTRACT

An artificial intelligence-driven system and method for software development lifecycle is disclosed. The method includes, receiving an input data from a plurality of data sources, preprocessing the input data to determine a file type of the input data, segmenting the plurality of preprocessed data into a plurality of data segments, and creating a plurality of technical design data based on the plurality of data segments. The method further includes, validating the created plurality of technical design data based on one of a prestored rules and a trained artificial intelligence model, creating a plurality of call graph relationship data by establishing a call graph relationship between the plurality of data segments, creating a plurality of summarized technical data, recommending a plurality of languages for translating the code, generating a plurality of translated code file in at least one target language selected by at least one user and outputting the plurality of translated code file to the at least one user through a user application interface.

### TECHNICAL FIELD

The present disclosure generally relates to the field of managing software development life cycle and, more particularly, to an artificial intelligence-driven software development lifecycle.

### BACKGROUND

Mainframe systems are computers used primarily by large organizations for critical applications, bulk data processing, enterprise resource planning, transaction processing, and/or the like. Mainframe systems are powerful, large-scale computing solutions designed to handle vast amounts of data and support critical applications for businesses and organizations. Known for their reliability, security, and processing capabilities, mainframes excel in transaction processing, bulk data management, and running enterprise-level applications. Despite their strengths, the mainframe systems are increasingly inadequate for meeting the complex data requirements of modern software developments and applications. For example, mainframe systems often fail to support the scalability and flexibility needed for today's fast-paced development environments. As a result, developers may face significant challenges, including time-consuming repetitive tasks such as searching for content and generating software artifacts manually. Traditional methods used alongside the mainframe systems lack adaptability and context-awareness, leading to communication gaps and misalignment in translating high-level requirements into actionable designs. This may result in a tedious, error-prone process of converting designs into code and unit test scripts, hindering overall productivity and software quality. Further, use of mainframe systems for modern software developments often leads to lower quality outputs characterized by inconsistencies and missed details. This may result in high costs due to rework and duplicated efforts, further exacerbating project delays and missed timelines. Additionally, the scalability of these systems may be inhibited, making it challenging to adapt to changing business needs.

### SUMMARY

This summary is provided to introduce a selection of concepts in a simple manner that is further described in the detailed description of the disclosure. This summary is not intended to identify key or essential inventive concepts of the subject matter nor is it intended for determining the scope of the disclosure.

An artificial intelligence-driven method for software development life cycle is disclosed. The method includes, receiving, by a processor, an input data from a plurality of data sources, wherein the input data comprises software development artifacts, preprocessing the input data using a plurality of learning models to determine a file type of the input data, segmenting the plurality of preprocessed data into a plurality of data segments based on the determined file type of the input data, and creating a plurality of technical design data based on a plurality of data segments, wherein the technical design data corresponds to description of the plurality of data segments in at least one language. The method further includes, validating the created plurality of technical design data based on one of a prestored rules and a trained artificial intelligence model, creating a plurality of call graph relationship data by establishing a call graph relationship between the plurality of data segments, wherein the establishment of the call graph relationship is based on determined file type of the input data. The method further includes, creating a plurality of summarized technical data by summarizing the created plurality of technical design data and the created plurality of call graph relationship data, recommending a plurality of languages for translating the code comprised in the plurality of summarized technical data, by analyzing the plurality of summarized technical data, generating a plurality of translated code file in at least one target language selected by at least one user, by performing the translation of the code comprised in the plurality of summarized technical data into the at least one target language and outputting the plurality of translated code file to the at least one user through a user application interface.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an example environment that may be used to execute implementations of the present disclosure;

FIG. 2 depicts an example architecture of the conversion system for converting the classic software into the modern software, in accordance with implementations of the present disclosure;

FIG. 3 is detailed block diagram of the conversion system, in accordance with an embodiment of the present disclosure; and

FIG. 4 is flowchart illustrating a method of converting a classic software into the modern software, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element. “First,” “second,” etc., are labels to distinguish components or blocks of otherwise similar names but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A. and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

To address the one or more limitations described in the background, embodiments of the present disclosure describe an artificial intelligence-driven system and method for software development lifecycle. Implementations of the present disclosure enable efficient conversion of mainframe code to a technical design document and conversion of the technical design document to a native language code.

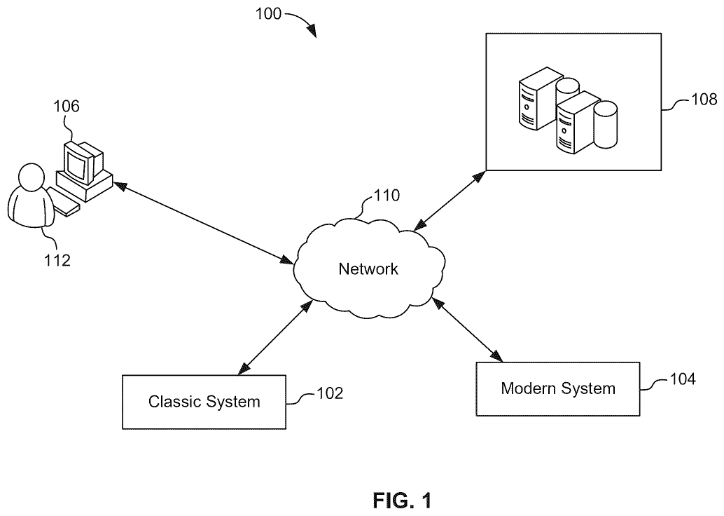

FIG. 1 depicts an example environment 100 that may be used to execute implementations of the present disclosure. In some examples, the example environment 100 manages conversion of mainframe code into native language code.

As depicted in FIG. 1, the example environment 100 includes a classic system 102, a modern system 104, a client device 106, and a conversion system 108. For simplicity, a single classic system, a single modern system, a single client device, and a single conversion system 108 are depicted in FIG. 1, however, the example environment 100 may include one or more classic systems, one or more modern systems, one or more client devices, and one or more conversion systems. The components 102-108 of the example environment 100 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The classic system 102 may be associated with an entity, which requires to replace the classic system 102 with the modern system 104. Replacing the classic system 102 with the modern system 104 may refer to converting the software being executed on the classic system 102 into a modern software for execution on the modern system 104. Examples of the entity associated with the classic system 102 may include, an organization, a corporation, a business unit of a corporation, a department of a corporation, a government agency, a banking unit, and/or the like. A non-limiting example of the classic system 102 may include a mainframe device. The classic system 102 may include a hardware platform with hardware components and a programmed computer (not depicted in FIG. 1). The hardware platforms may be controlled by the programmed computer. The programmed computer may execute the classic software. The classic software may refer old or outdated software, for example Common Business-Oriented Language (COBOL), which is either no longer operable on the classic system 102 or for which upgrades are either not available or cost effective. In some examples, the classic software/application may be used for bulk data processing, entity/enterprise resource planning, transaction processing, and/or the like.

The modern system 104 may have improved hardware design compared to the classic system 102. Examples of the modern system 104 may include, but are not limited to, a cloud computing system, a distributed server system, and/or the like. The modern system 104 may execute the modern software corresponding to the classic software.

The client device 106 may be used by a respective user 112 to log into and interact with computing platforms executing software conversion applications. Examples of the client device 106 may include a desktop computing device, a smartphone, a laptop, tablet, a voice-enabled device, and/or the like. It is contemplated that implementations of the present disclosure may be realized with any appropriate type of computing device. In some examples, the client device 106 may display one or more Graphical User Interfaces (GUIs) that enable the user 112 to interact with the computing platform executing the software conversion applications. Interacting with the computing platform may include identifying the mainframe software to be converted into the modern software for execution on the modern system 104.

In some examples, the conversion system 108 may be implemented as an on-premises system that is operated by an enterprise or a third-party engaged in cross-platform interactions and software conversion management. In some examples, the conversion system 108 may be implemented as an off-premises system (for example, cloud or on-demand) that is operated by an enterprise or a third-party on behalf of an enterprise. In some examples, the conversion system 108 may be implemented in a cloud environment. For simplicity, the conversion system 108 depicted in FIG. 1 may be a cloud environment that is intended to represent various forms of servers including a web server, an application server, a proxy server, a network server, a server pool, and/or the like. In some examples, the conversion system 108 hosts the software conversion applications, which may be executed on the computing platforms for identifying the classic software for conversion.

In accordance with implementations of the present disclosure, the conversion system 108 converts the classic software (written in COBOL, for example) into the modern software (GCP native language, for example). The modern software may provide functionality of the classic software and may be operated entirely on the modern system 104. Various examples of converting the classic software into the modern software are described in detail in the present disclosure.

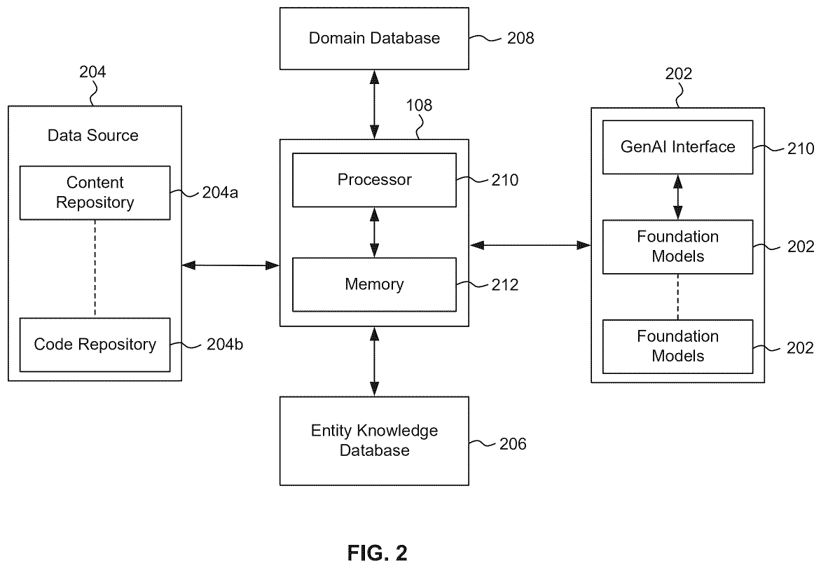

FIG. 2 depicts an example architecture of the conversion system 108 for converting the classic software into the modern software, in accordance with implementations of the present disclosure. As depicted in FIG. 2, the conversion system 108 may be communicatively coupled to a Generative Artificial Intelligence (GenAI) system 202, and various repositories such as, a plurality of data sources (shown one data source 204), an entity knowledge database 206 and a domain database 206. The GenAI system 202 and the various repositories 204-208 may be accessed by the conversion system 108 for converting the classic software into the modern software.

The GenAI system 202 may include foundation models 202a-202n. In some examples, the foundation models 202a-202n may be hosted on a same hosting infrastructure. In some other examples, the foundation models 202a-202n may be hosted on different hosting infrastructures. An example of the hosting infrastructure may include a cloud computing platform or the like. Further, the foundation models 202a-202n may be hosted in different types of paradigms, which include, without limitation, model-as-a service (MaaS) models, specialized MaaS (SMaaS) models, self-deployed models, and/or the like.

The foundation models 202a-202n may be described as general-purpose GenAI models like large deep learning neural networks. For example, the foundation models 202a-202n may include Large Language Models (LLMs), which are a form of GenAI that may be used to generate text for a variety of use cases. In some examples, the LLMs may be integrated in digital assistants (for example, chatbots), replacing traditional rule-based systems to provide textual responses to an input. The LLMs may generate human-like text and perform various Natural Language Processing (NLP) tasks (for example, translation, question-answering, and/or the like). In some examples, the LLMs refer to models that use deep learning techniques and have a plurality of parameters, which may range from millions to billions. The LLMs may capture complex patterns in language and produce text that is often indistinguishable from that written by humans. The produced text may be processed through a deep learning architecture such as, recurrent neural network (RNN), a transformer model, and/or the like. For another example, the foundation models 202a-202n may include vision language models. The vision language models may learn simultaneously from images and texts to perform many tasks from visual question answering to image captioning. Therefore, the foundation models 202a-202n may include multi-modal models that learn from images and text.

The GAI system 202 further includes a GAI/Gen AI interface 210 for interacting with the foundation models 202a-202n of the GAI system 202. The foundation models 202a-202n may provide various GenAI services including, but not limited to, text generation, embedding generation, image generation, audio generation, video generation, and/or the like.

While implementations of the present disclosure are described in further detail herein with non-limiting reference to the foundation models 202a-202n, it is contemplated that implementations of the present disclosure may be realized using any Machine Learning (ML) models, or Artificial Intelligence (AI) models, or any other similar models.

The data source 204 (each of the one or more data sources) may include a content repository 204a, a code repository 204b, etc. Hence the data source 04 may store the classic software and supporting content. In some examples, the user associated with the client device 106 may upload the classic software in a excel format or as a form or in any known format. The classic software (for example a software code in COBAL) may include multiple files (also be referred to as codes, modules, or the like). In some examples, the files may include code files, audio files, image files, summary code files, and/or the like. Each of the code files may include multiple line of codes (LOC). In some examples, the supporting content may include a domain, Key Performance Indicators (KPIs), processes/operations, and/or the like, associated with the classic software.

The entity knowledge database 206 acts as a repository for storing a metadata, and intermediate data generated during the code conversion. In some examples, the entity knowledge database 206 may be regularly updated from a template repository along with the metadata. The metadata may include successful conversion information/stories and process management levels. In some examples, the successful conversion information may include benchmark reports related to successful conversion of the classic software into the modern software (hereinafter referred to as conversion), a client technology stack, outcomes generated from the conversion, templates and the foundation models 202a-202n used for the conversion, volume of the conversion, an accuracy of the conversion, time and/or the like. The templates (also be referred to as patterns) may indicate a sequence of steps executed for the conversion.

The domain database 208 includes a vector database, a graph database, and a prompt database. The vector database stores information as vectors. The vectors (also be referred to as vector embeddings) may be numerical representation of the information. In implementations disclosed herein, the information may include prompts/requests generated for the foundation models 202a-202n and responses generated using the foundation models 202a-202n for the prompts/requests. The responses may indicate results execution of the sequence of steps/templates. The graph database stores one or more graphs generated based on the results of execution of the sequence of steps/templates. The prompt database stores the prompts generated for the foundation models 202a-202n. It should be noted that storing information in the domain database 208 may refer to storing the information in any of the vector database, the graph database, and the prompt database. The information herein may include the prompts, the results of execution, and/or the like.

Still referring to FIG. 2, the conversion system 108 includes a processor 210, and a memory 212. The conversion system 108 may also include other components such as communication interfaces, Input/Output (I/O) devices, and so on (not depicted in FIG. 2).

In some examples, the processor 210 may include one or more processors. Examples of the processor 210 may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 210 may be programmed to cooperate with computer-readable instructions stored in the memory 212 (also referred to be as computer-readable medium) for performing operations according to the present disclosure. The memory 212 may be non-transitory or non-volatile medium, such as a magnetic disk or solid-state non-volatile memory or volatile medium such as Random Access Memory (RAM), and/or the like.

In an embodiment of the present disclosure, the conversion system 108 receives an input data from a plurality of data sources 204, wherein the input data includes software development artifacts. Then the conversion system 108 preprocesses the input data, using a plurality of learning models 202a-202n to determine a file type of the input data, segments the plurality of preprocessed data into a plurality of data segments based on the determined file type of the input data, and creates a plurality of technical design data based on the plurality of data segments, wherein the technical design data corresponds to description of the plurality of data segments in at least one language. Further, the conversion system 108 validates the created plurality of technical design data based on one of a prestored rules and a trained artificial intelligence model and creates a plurality of call graph relationship data by establishing a call graph relationship between the plurality of data segments, wherein the establishment of the call graph relationship is based on determined file type of the input data. Furthermore, the conversion system 108 creates a plurality of summarized technical data by summarizing the created plurality of technical design data and the created plurality of call graph relationship data and recommends a plurality of languages for translating the code comprised in the plurality of summarized technical data, by analyzing the plurality of summarized technical data. Furthermore, conversion system 108 generates a plurality of translated code file in at least one target language selected by at least one user, by performing the translation of the code comprised in the plurality of summarized technical data into the at least one target language and outputs the plurality of translated code file to the at least one user through a user application interface. The manner in which the conversion system 108 performs the above steps to covert the mainframe code to a native language code is described below in further detail.

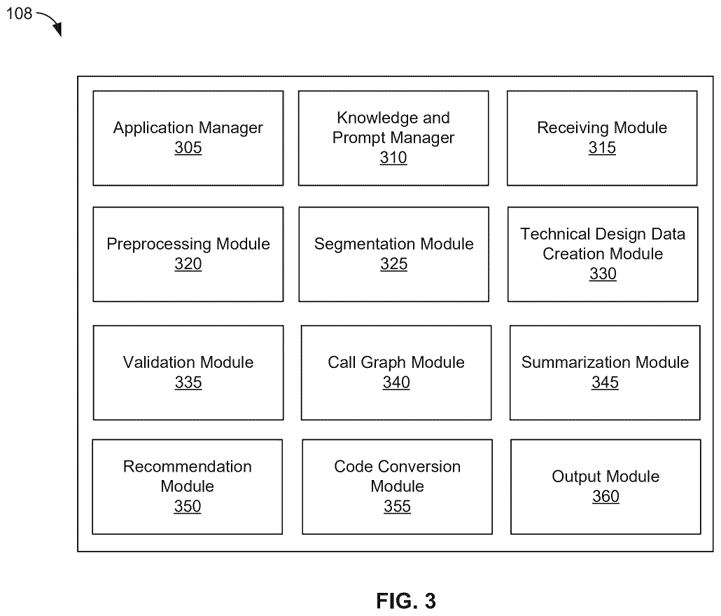

FIG. 3 is detailed block diagram of the conversion system, in accordance with an embodiment of the present disclosure. As shown, the conversion system 108 includes an application manager 305, a knowledge and prompt manager 310, a receiving module 315, a preprocessing module 320, a segmentation module 325, technical design data creation module 330, a validation module 335, a call graph module 340, a summarization module 345, a recommendation module 350, a code conversion module 355, and an output module 360.

The application manager 305 may include non-limiting example applications of chatbots, voice assistants, and/or the like, for receiving user input from the client device 106. The user input may indicate the classic software to be converted. In some other examples, the application manager 305 may include a User Interface (UI) (e.g., a chatbot displayed in a Graphical User Interface (GUI)) or other user-accessible interface to enable the client device 106 to provide the user input.

The knowledge and prompt manager 310 may be described as a context setting layer that hosts an organizational knowledge as a searchable interface. For example, the prompts to the foundation models 202a-202n are augmented with domain data and/or organizational data through the knowledge manager and prompt manager 310. That is, the knowledge and prompt manager 310 is configured to gather and organize the domain data and/or organizational data from internal databases, documents, or external sources. Such data is then formatted to usable structure by integrating into the prompts. Further, the knowledge and prompt manager 310 may be configured for prompt development and management, and language modeling. The knowledge and prompt manager 310 may provide the prompts that represent queries in an appropriate sequence to the foundation models 202a-202n. The knowledge and prompt manager 310 may further connect with the vector database and the graph database to provide, for example, domain-based context and other details to the foundation models 202a-202n, which enables the foundation models 202a-202n to correctly interpret the prompts and generate the responses.

In an embodiment, the input data to the conversion system 108 includes software development artifacts of the classic software. Hence, the receiving module 315 receives the software development artifacts of the classic software identified by the client device 106 for the conversion. The software development artifacts as described herein may include, but are not limited to, stories, epics and features. The stories may include informal descriptions of a software feature from the user's perspective, the epics may include large bodies of work that encompass multiple features and user stories, and the features may include higher-level descriptions of a set of related user stories that deliver a specific capability or functionality within the software. In addition, the software development artifacts may include requirement artifacts, design artifacts, implementation and development artifacts, testing artifacts, and any supporting documents, etc. The receiving module 315 may retrieve the software artifacts from the one or more repositories of the one or more data sources 204. Examples of the classic language may include, COBOL, PASCAL, Assembler, Job Control Language (JCL), and so on. The classic software may include multiple files/codes (also be referred to as data or content of the software). The multiple files may distributed/saved across the different data sources 204.

Upon receiving the input data, the preprocessing module 320 processes the input data using one or more learning models 202a-202n to determine a file type of the input data, that is, the file type of the software development artifacts. In an embodiment, the preprocessing module 320 extracts a first set of data from the input data, wherein the first set of data corresponds to a subset of the input data. Then the preprocessing module 320 determines the type using the GenAI models, wherein the file type may include copybook type, a mapset type, and a Job Control Language (JCL) type, etc. In some examples, the file type of the input data may further include a software/application code, images, non-software text, dependency files, word documents, presentation files, PDF files, excel workbooks, copybooks, and/or the like. In some examples, the file types may be augmented with SME inputs, external Application Programming Interface (API) content, and/or the like.

Then the segmentation module 325 segments the preprocessed data into a plurality of data segments based on the determined file type of the input data. In an embodiment, the segmentation module 325 identifies a plurality of logical sections present in the plurality of preprocessed data, based on the determined file type, wherein the plurality of logical sections includes at least one of a plurality of program divisions and a plurality of functional modules. Then the segmentation module 325 segments the plurality of preprocessed data into the plurality of data segments based on the identified plurality of logical sections.

The segmentation of the preprocessed data into distinct data segments based on the determined file type enhances the organization and accessibility of the data for subsequent processing tasks. As described, initially the segmentation module 325 determines the file type of the input data. The segmentation module 325 evaluates the data to classify it accurately, which is essential for subsequent segmentation strategy. By understanding the file type, the segmentation module 325 applies the appropriate rules and methods for organizing the data. Then the segmentation module 325 identifies a plurality of logical sections within the preprocessed data. These logical sections are defined as program divisions, which represent various segments of code or definitions, and functional modules, which encapsulate distinct functionalities or operations. This identification process is key to understanding how the data is structured and how the data can be effectively segmented. Finally, leveraging the identified logical sections, the segmentation module 325 segments the preprocessed data into a structured format, resulting in a plurality of data segments. This segmentation aligns with the logical organization dictated by the file type, facilitating improved data management. The resulting segments enable efficient processing, retrieval, and analysis in subsequent operations.

Then, in an embodiment of the present disclosure, the technical design data creation module 130 creates a plurality of technical design data based on the plurality of data segments, wherein the technical design data corresponds to description of the plurality of data segments in at least one language. Hene, the module 130 creates a plurality of technical design data based on the segmented data, allowing for clear documentation and understanding of each data segment. The created technical design data serves as a comprehensive description of the segments.

In an embodiment, technical design data creation module 130 initiates the creation process by analyzing the previously segmented data. For each data segment, the module 130 generates technical design data that includes specifications and characteristics relevant to that segment. This data encompasses various aspects, such as data types, structures, relationships, and intended functionalities, ensuring a thorough understanding of how each segment operates within the broader system. In an embodiment, the technical design data is produced in at least one programming language or documentation format. In an embodiment of the present disclosure, the technical design data is created using Python and GenAI framework. The GenAI analyzes the legacy code, understands the code with respect to purpose, methods used, dependencies and exception, and then drafts the technical design for the data. This allows for versatility in how the information is presented and utilized, catering to the preferences of different project requirements. By providing descriptions in familiar languages, the module 130 enhances the accessibility of the information, making it easier for further implementation and integration of the data segments into their applications.

Further, the validation module 335 validates the created plurality of technical design data based on one of a prestored rules and a trained artificial intelligence model. In an embodiment, the validation module 335 maps the plurality of key components associated with the generated plurality of technical design data with a plurality of key components associated with the input data, and validates the plurality of generated technical design data, based on the mapping. The mapping is essential for establishing a relationship between the two data sets, enabling the validation module 335 to assess whether the technical design data accurately reflects the input data's structure and requirements. Once the mapping is complete, the validation module 335 evaluates the plurality of generated technical design data against the established mapping. This validation process ensures that the technical design data is consistent with the original input data, verifying that all critical components are accounted for and correctly represented. Hence, the validation module 335 facilitates identification of any discrepancies or issues that may arise, thereby enhancing the reliability of the conversion system 108. It is to be noted that the validation module 335 validates generated plurality of technical design data by utilizing either a prestored set of rules or a trained artificial intelligence model, depending on the specific implementation. For example, generated technical design data of the generated code is compared with the originally created data to validate the technical design data. Alternatively, GenAI may be used to determine the variance in the code generated and the original technical design data.

Further, in an embodiment of the present disclosure, the call graph module 340 creates a plurality of call graph relationship data by establishing a call graph relationship between the plurality of data segments, wherein the establishment of the call graph relationship is based on determined file type of the input data. In an embodiment, the call graph module 340 maps the plurality of data segments having a similar file type based on a file type of the plurality of data segments. By categorizing the segments based on their file type, the call graph module 340 focuses on the relevant groupings, which helps streamline the subsequent analysis. This mapping process is essential for identifying relationships and dependencies that are inherent to segments of the same type. Once the mapping is completed, the call graph module 340 establishes the call graph relationship between the plurality of data segments, based on the mapped plurality of data segments, wherein the call graph relationship corresponds to dependencies between the plurality of data segments. These relationships represent the dependencies among the segments, effectively illustrating how they interact with one another within the broader system. By capturing these dependencies, the call graph module provides valuable insights into the structure and functionality of the software, facilitating a better understanding of data flow and control.

Upon generating the plurality of technical design data and the plurality of call graph relationship data, the summarization module 345 creates a plurality of summarized technical data by summarizing the created plurality of technical design data and the created plurality of call graph relationship data. The summarization module 345 synthesizes the previously generated technical design and call graph relationship data, condensing the information into a more manageable and comprehensible format. The summarization process involves analyzing both the technical design data, which describes the structure and functionality of the data segments, and the call graph relationship data, which outlines the dependencies and interactions among these segments. By integrating these two data sets, the summarization module 345 refines essential insights and key information that reflect the overall architecture and behavior of the software. Hence, the summarization is done by analyzing all the technical design data created and the established relationship between each code. The relationship is identified and depicted using call graph module.

Then the recommendation module 350 recommends a plurality of languages for translating the code comprised in the plurality of summarized technical data, by analyzing the plurality of summarized technical data. In an embodiment, the recommendation module 350 determines a plurality of conversion factors for the code included in the plurality of summarized technical data, using the one or more GenAI model 202a-202n, wherein the plurality of conversion factors comprise at least a syntax compatibility factor, a functionality factor, and a use case factor. Then the recommendation module 350 recommends the plurality of languages for translation of the code included in the plurality of summarized technical data, based on the determined conversion factors.

Hence, the recommendation module 350 organizes the code translation process by recommending appropriate programming languages for the code present in the summarized technical data. Initially, the recommendation module 350 analyzes the summarized technical data to identify key attributes of the code that may impact its translation. To enhance the accuracy of recommendations, the module utilizes one or more GenAI models 202a-202n to determine a set of conversion factors essential for effective code translation. For example, the syntax compatibility factor may assess how closely the syntax of the source code aligns with that of potential target languages, ensuring that the translated code can be written correctly and without errors. Further, the functionality factor evaluates whether the target languages can adequately replicate the functionality of the original code, ensuring that the translated version behaves as intended. Furthermore, the use case factor considers the specific contexts or scenarios in which the code will be used, guiding the recommendation towards languages that are most suited for those particular applications. Upon determining the conversion factors, the recommendation module 350 utilizes such factors to generate a list of recommended programming languages for translating the code. Further, the recommendation module 350 recommends the one or more programming languages to the user by displaying the client device 106 thereby enables the user to select a programming language from among the one or more programming languages. For example, the recommendation module 350 analyzes technical design data to understand the type of code that needs to be converted, for example whether the code deals with frontend or backend. The recommendation module 350 further determines what the code is trying to achieve like the functionality of the code, syntax of the code. Based on these parameters the technical design data is analyzed using Gen AI models and language which matches the criteria are selected for conversion and recommends to the user.

Then the code conversion module 355 generates a plurality of translated code file in at least one target language selected by the user, by performing the translation of the code included in the plurality of summarized technical data into the at least one target language. Further, the output module 360 outputs plurality of translated code file to the at least one user through a user application interface of the client device 106. It is to be noted that the generate codes may be stored in a data source for further usage by the end users. Hence, the code conversion module 355 takes the summarized technical data, which contains essential information about the original code, and performs the necessary translations to create functional code in the desired programming language. Upon receiving the target language(s) selected by the user, the code conversion module 355 analyzes the summarized technical data to identify the specific code segments that need to be translated. The code conversion module 355 applies predefined translation rules, algorithms, and methodologies to ensure that the original code's syntax and functionality are accurately preserved in the new language. The code conversion module 355 initially parses the source code by performing lexical analysis and syntax analysis and generates a syntax tree that represents the code's structure. Optionally, the syntax tree is transformed into an intermediate representation that is more abstract and easier to manipulate. Then the intermediate representation is transformed to the target language which involves mapping constructs from the source language to equivalent constructs in the target language and differences in syntax, libraries, and handling paradigms between the two languages. For example, if the user selects the input language python for a particular COBOL code type, then the code conversion module 355 checks the created technical design document of the COBOL code and applies the identified algorithm, methodologies as mentioned in technical design document, captured from the original code, to the new code and thus generates the code in the target language which aligns with functionality of the original code. The translation process encompasses several considerations, including syntax compatibility, functionality mapping, and adherence to best practices in the target language. Once the translation is complete, the code conversion module generates a plurality of translated code files, outputting them in the specified target language. This functionality streamlines the development workflow, allowing developers to leverage existing code in new environments or applications without extensive manual rewriting.

In an embodiment of the present disclosure, the code conversion module 355 determines whether the at least one target language selected by the at least one user is within the recommended plurality of languages for translation, and then determines a plurality of output efficiency parameters for each of the recommended plurality of languages for translation. Further, the code conversion module 355 a priority list for the recommended plurality of languages for translation, based on the determined plurality of output efficiency parameters, and converts the code included in the plurality of summarized technical data into a secondary language having a highest priority. In this implementation, the code conversion module 355 initially determines whether the target language selected by the user is among the recommended plurality of languages identified for translation. This validation step ensures that the user's choice aligns with the suggested options based on the previously established conversion factors, thereby optimizing the translation process and enhancing compatibility. Following the validation, the code conversion module 355 evaluates a set of output efficiency parameters for each of the recommended languages. In an embodiment, the output efficiency parameters may include metrics such as but not limited to, execution performance, maintainability, compatibility, conversion time, etc. The execution performance assesses how efficiently the translated code runs in the target language, maintainability evaluates how easy it is to maintain and update the translated code, compatibility checks how well the translated code integrates with existing systems, libraries, or frameworks within the target language ecosystem, and the conversion time is an estimation the time required to convert and test the code in each recommended language. By determining these output efficiency parameters, the processor provides valuable insights that aid the user in making informed decisions about language selection. This ensures that the final choice of target language aligns with project goals regarding performance, maintainability, and resource efficiency alongside the technical requirements.

In an embodiment, before outputting the translated code, the output module 360 validates the plurality of translated code file by identifying at least one error parameter associated with the plurality of translated code file, wherein the at least one error parameter includes at least a code issue parameter, a syntax error parameter, and a security vulnerability parameter, and output the at least one error parameter to the at least one user through the user application interface. That is, output module 360 outputs the translated code files to the user via a user application interface, ensuring that the output is both reliable and informative. This involves a two-step validation process that assesses the quality of the translated code files before they are delivered to the user. Initially, the output module 360 validates the plurality of translated code files by identifying error parameters such as code issue parameter, syntax error parameter, and security vulnerability parameter. The code issue parameter highlights potential issues in the logic or structure of the translated code that may affect its functionality or performance, the syntax error parameter highlights any syntax errors that could prevent the code from compiling or executing correctly in the target language, and security vulnerability parameter highlights the potential security risks, such as vulnerabilities. Upon identifying such error parameters, the output module 360 outputs the relevant information to the user through the user application interface. This output provides the user with a clear understanding of any issues that may exist within the translated code files, enabling them to address these errors before further integration or deployment.

Considering a COBOL code which needs to be converted into a native language, the COBOL code is uploaded to a designated cloud storage bucket, for example the data source. This ensures that the code is accessible by the system disclosed in the present disclosure. Then the system performs preprocessing. During this process, the system extracts the codes (for example first 1,000 lines of the COBOL file) using Python libraries, for example. This is done to handle large files more efficiently and to limit the input for initial analysis.

Then the system classifies the COBOL code type using GenAI models. In this process, the system feeds the extracted code to a GenAI model. In an embodiment, GenAI models such as Gemini, Codey is used. The usage of these models is customized to take the sample COBOL program type as one input parameter and applies GenAI capabilities to compare it with the fed COBOL code and establishes the type of the code. The purpose of this is to identify and classify the COBOL code based on its type, such as, Copybook (for reusable code segments), Mapset (for screen definitions), or JCL (for batch processing instructions), etc. In some cases, COBOL files, especially large ones, can exceed the token limits for GenAI prompts. In such a scenario, custom chunking logic is applied to break down (into segments) the code into smaller, meaningful components based on logical sections of the code (such as program divisions or functional modules). This ensures that the chunks stay within the token limit while preserving the structure and meaning of the original code. Each chunk is then prepared for input into the GenAI for deeper analysis.

Then the system creates the technical design document using Codey Python Framework, for example. For this, the chunked COBOL code is passed through the Codey Python framework. This framework performs initially generates a technical design document (including technical design data), establishes dependencies using call graph, and creates an overall summary document. To generate the technical design document, the Codey framework analyzes the COBOL code and generates a technical design document. This document provides a simplified, English-language description of the COBOL program. The document organizes the program's structure into clear categories, making it easier to understand for both technical and non-technical stakeholders. Further, the relationships between different COBOL components (e.g., programs, copybooks, JCL) are established using a call graph. The call graph visually represents which parts of the program call or rely on other components, helping to illustrate the program's internal dependencies. Once the individual technical design documents and the call graphs are generated for each code chunks, they are passed to the GenAI, which compiles them into an overall summary document. This summary consolidates all the design information and includes the call graph relationships, providing a high-level overview of the entire COBOL program.

The summary document, including the technical data, is made available to the user for review, verification and modifications by the end user, if necessary. The modified summary documents may be further uploaded for further processing.

Then the final summary document is passed into a GenAI prompt that is customized to analyze the document. Based on the contents and structure of the COBOL code, the GenAI provides language recommendations. In an embodiment, the GenAI models are configured to suggest the top three programming languages in which the COBOL code could be converted, based on factors such as syntax compatibility, functionality, and use case. This recommendation can also be expanded to include all possible languages supported by the system. However, if the COBOL code is backend-related, the GenAI will restrict the recommendations to backend languages (e.g., Java, Python, or C#), excluding frontend languages (e.g., JavaScript or HTML).

Then the user may review the recommended languages and selects the one that best fits their requirements or preferences for conversion. Once the user has selected the desired language, the system generates the equivalent code in that language based on the technical design document, that is the summary document. The generated code is aligned with the structural and functional requirements of the original COBOL program, ensuring it operates correctly in the new language.

As described, the system disclosed in the present disclosure enable efficient conversion of mainframe code to a technical design document and conversion of the technical design document to a native language code. Furthermore, one of ordinary skill in the art will appreciate that while an example embodiment with respect to COBOL code is described above, the present disclosure is not limited to the same. That is, systems and methods consistent with the present disclosure can be used to convert any software language to a native language desired by a user.

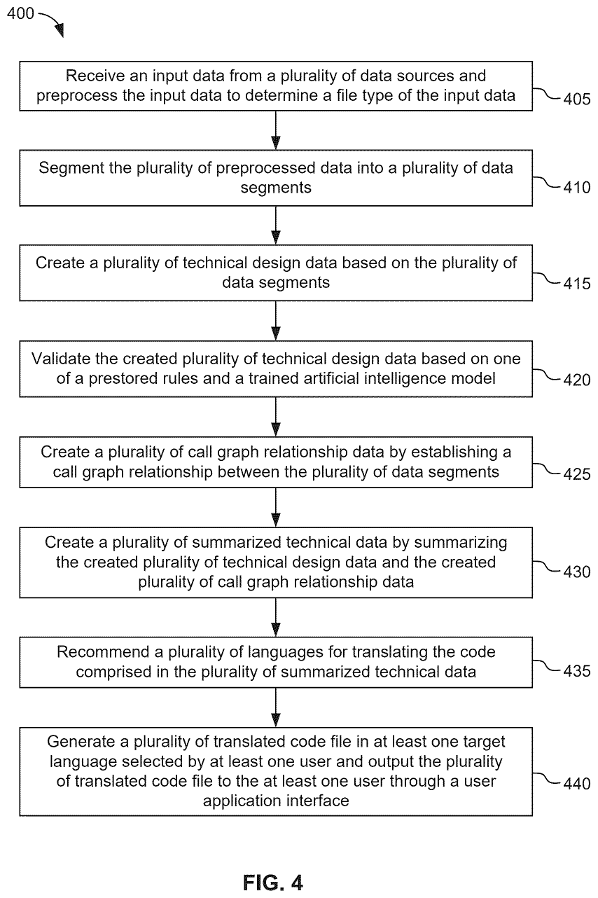

FIG. 4 is flowchart illustrating a method of converting a classic software into the modern software, in accordance with implementations of the present disclosure. It is to be noted that the method is performed by the conversion system 108 depicted in FIG. 2 which may be communicatively coupled to the GenAI system 202, and various repositories such as, a plurality of data sources (shown one data source 204), an entity knowledge database 206 and a domain database 206. The GenAI system 202 and the various repositories 204-208 may be accessed by the conversion system 108 for converting the classic software into the modern software.

Initially, at step 405, the conversion system 108 receives the input data from a plurality of data sources and the received data is preprocessed to determine a file type of the input data. The input data may be received from the user through chatbots, voice assistants, and/or the like. The user input may indicate the classic software to be converted. In an embodiment, the input data to the conversion system 108 includes software development artifacts of the classic software. Hence, the conversion system, 108 receives the software development artifacts of the classic software identified by the client device 106 for the conversion. The software development artifacts as described herein may include, but are not limited to, stories, epics and features. The stories may include informal descriptions of a software feature from the user's perspective, the epics may include large bodies of work that encompass multiple features and user stories, and the features may include higher-level descriptions of a set of related user stories that deliver a specific capability or functionality within the software. In addition, the software development artifacts may include requirement artifacts, design artifacts, implementation and development artifacts, testing artifacts, and any supporting documents, etc. The conversion system 108 may retrieve the software artifacts from the one or more repositories of the one or more data sources 204. Examples of the classic language may include, COBOL, PASCAL, Assembler, Job Control Language (JCL), and so on. The classic software may include multiple files/codes (also be referred to as data or content of the software). The multiple files may distributed/saved across the different data sources 204.

Upon receiving the input data, the conversion system 108 processes the input data using one or more learning models 202a-202n to determine a file type of the input data, that is, the file type of the software development artifacts. In an embodiment, the conversion system 108 extracts a first set of data from the input data, wherein the first set of data corresponds to a subset of the input data. Then the conversion system 108 determines the type using the GenAI modesl, wherein the file type may include copybook type, a mapset type, and a Job Control Language (JCL) type, etc. In some examples, the file type of the input data may further include a software/application code, images, non-software text, dependency files, word documents, presentation files, PDF files, excel workbooks, copybooks, and/or the like. In some examples, the file types may be augmented with SME inputs, external Application Programming Interface (API) content, and/or the like.

At step 410, the conversion system 108 segments the preprocessed data into a plurality of data segments based on the determined file type of the input data. In an embodiment, the conversion system 108 identifies a plurality of logical sections present in the plurality of preprocessed data, based on the determined file type, wherein the plurality of logical sections includes at least one of a plurality of program divisions and a plurality of functional modules. Then the segmentation module 325 segments the plurality of preprocessed data into the plurality of data segments based on the identified plurality of logical sections.

The segmentation of the preprocessed data into distinct data segments based on the determined file type enhances the organization and accessibility of the data for subsequent processing tasks. As described, initially the conversion system 108 determines the file type of the input data and evaluates the data to classify it accurately, which is essential for subsequent segmentation strategy. By understanding the file type, the conversion system 108 applies the appropriate rules and methods for organizing the data. Then the conversion system 108 identifies a plurality of logical sections within the preprocessed data. These logical sections are defined as program divisions, which represent various segments of code or definitions, and functional modules, which encapsulate distinct functionalities or operations. Finally, leveraging the identified logical sections, the conversion system 108 segments the preprocessed data into a structured format, resulting in a plurality of data segments.

At step 415, the conversion system 108 creates a plurality of technical design data based on the plurality of data segments, wherein the technical design data corresponds to description of the plurality of data segments in at least one language. Hene, the conversion system 108 creates a plurality of technical design data based on the segmented data, allowing for clear documentation and understanding of each data segment. The created technical design data serves as a comprehensive description of the segments.

In an embodiment, creation of technical design data is initiated by analyzing the previously segmented data. For each data segment, the conversion system 108 generates technical design data that includes specifications and characteristics relevant to that segment. This data encompasses various aspects, such as data types, structures, relationships, and intended functionalities, ensuring a thorough understanding of how each segment operates within the broader system. In an embodiment, the technical design data is produced in at least one programming language or documentation format. This allows for versatility in how the information is presented and utilized, catering to the preferences of different project requirements. By providing descriptions in familiar languages, conversion system 108 enhances the accessibility of the information, making it easier for further implementation and integration of the data segments into their applications.

At step 420, the conversion system 108 validates the created plurality of technical design data based on one of a prestored rules and a trained artificial intelligence model. In an embodiment, the conversion system 108 maps the plurality of key components associated with the generated plurality of technical design data with a plurality of key components associated with the input data, and validates the plurality of generated technical design data, based on the mapping. The mapping is essential for establishing a relationship between the two data sets, enabling the conversion system 108 to assess whether the technical design data accurately reflects the input data's structure and requirements. Once the mapping is complete, the conversion system 108 evaluates the plurality of generated technical design data against the established mapping.

At step 425, the conversion system 108 creates a plurality of call graph relationship data by establishing a call graph relationship between the plurality of data segments, wherein the establishment of the call graph relationship is based on determined file type of the input data. In an embodiment, the conversion system 108 maps the plurality of data segments having a similar file type based on a file type of the plurality of data segments. By categorizing the segments based on their file type, the conversion system 108 focuses on the relevant groupings, which helps streamline the subsequent analysis Once the mapping is completed, the conversion system 108 establishes the call graph relationship between the plurality of data segments, based on the mapped plurality of data segments, wherein the call graph relationship corresponds to dependencies between the plurality of data segments. These relationships represent the dependencies among the segments, effectively illustrating how they interact with one another within the broader system.

Upon generating the plurality of technical design data and the plurality of call graph relationship data, at step 430, the conversion system 108 creates a plurality of summarized technical data by summarizing the created plurality of technical design data and the created plurality of call graph relationship data. The conversion system 108 synthesizes the previously generated technical design and call graph relationship data, condensing the information into a more manageable and comprehensible format. The summarization process involves analyzing both the technical design data, which describes the structure and functionality of the data segments, and the call graph relationship data, which outlines the dependencies and interactions among these segments. By integrating these two data sets, the conversion system 108 refines essential insights and key information that reflect the overall architecture and behavior of the software.

At step 435, the conversion system 108 recommends a plurality of languages for translating the code comprised in the plurality of summarized technical data, by analyzing the plurality of summarized technical data. In an embodiment, the conversion system 108 determines a plurality of conversion factors for the code included in the plurality of summarized technical data, using the one or more GenAI model 202a-202n, wherein the plurality of conversion factors comprise at least a syntax compatibility factor, a functionality factor, and a use case factor. Then the conversion system 108 recommends the plurality of languages for translation of the code included in the plurality of summarized technical data, based on the determined conversion factors.

Hence, the conversion system 108 organizes the code translation process by recommending appropriate programming languages for the code present in the summarized technical data. Initially, the conversion system 108 analyzes the summarized technical data to identify key attributes of the code that may impact its translation. To enhance the accuracy of its recommendations, the module utilizes one or more GenAI models 202a-202n to determine a set of conversion factors essential for effective code translation. For example, the syntax compatibility factor may assess how closely the syntax of the source code aligns with that of potential target languages, ensuring that the translated code can be written correctly and without errors. Further, the functionality factor evaluates whether the target languages can adequately replicate the functionality of the original code, ensuring that the translated version behaves as intended. Furthermore, the use case factor considers the specific contexts or scenarios in which the code will be used, guiding the recommendation towards languages that are most suited for those particular applications. Upon determining the conversion factors, the conversion system 108 utilizes such factors to generate a list of recommended programming languages for translating the code. Further, the conversion system 108 recommends the one or more programming languages to the user by displaying the client device 106 thereby enables the user to select a programming language from among the one or more programming languages.

At step 440, the conversion system 108 generates a plurality of translated code file in at least one target language selected by at least one user and output the plurality of translated code file to the at least one user through a user application interface. In one embodiment, the conversion system 108 generates a plurality of translated code file in at least one target language selected by the user, by performing the translation of the code included in the plurality of summarized technical data into the at least one target language. Further, the conversion system 108 outputs plurality of translated code file to the at least one user through a user application interface of the client device 106. It is to be noted that the generate codes may be stored in a data source for further usage by the end users. Hence, the conversion system 108 takes the summarized technical data, which contains essential information about the original code, and performs the necessary translations to create functional code in the desired programming language. Upon receiving the target language(s) selected by the user, the conversion system 108 analyzes the summarized technical data to identify the specific code segments that need to be translated. The conversion system 108 applies predefined translation rules, algorithms, and methodologies to ensure that the original code's syntax and functionality are accurately preserved in the new language. The translation process encompasses several considerations, including syntax compatibility, functionality mapping, and adherence to best practices in the target language. Once the translation is complete, the code conversion module generates a plurality of translated code files, outputting them in the specified target language. This functionality streamlines the development workflow, allowing developers to leverage existing code in new environments or applications without extensive manual rewriting.

In an embodiment of the present disclosure, the conversion system 108 determines whether the at least one target language selected by the at least one user is within the recommended plurality of languages for translation, and then determines a plurality of output efficiency parameters for each of the recommended plurality of languages for translation. Further, the code conversion system 108 creates a priority list for the recommended plurality of languages for translation, based on the determined plurality of output efficiency parameters, and converts the code included in the plurality of summarized technical data into a secondary language having a highest priority. In this implementation, the conversion system 108 initially determines whether the target language selected by the user is among the recommended plurality of languages identified for translation. This validation step ensures that the user's choice aligns with the suggested options based on the previously established conversion factors, thereby optimizing the translation process and enhancing compatibility. Following the validation, the conversion system 108 evaluates a set of output efficiency parameters for each of the recommended languages. In an embodiment, the output efficiency parameters may include metrics such as but not limited to, execution performance, maintainability, compatibility, conversion time, etc. The execution performance assesses how efficiently the translated code runs in the target language, maintainability evaluates how easy it is to maintain and update the translated code, compatibility checks how well the translated code integrates with existing systems, libraries, or frameworks within the target language ecosystem, and the conversion time is an estimation the time required to convert and test the code in each recommended language. By determining these output efficiency parameters, the processor provides valuable insights that aid the user in making informed decisions about language selection. This ensures that the final choice of target language aligns with project goals regarding performance, maintainability, and resource efficiency alongside the technical requirements.

In an embodiment, before outputting the translated code, the conversion system 108 validates the plurality of translated code file by identifying at least one error parameter associated with the plurality of translated code file, wherein the at least one error parameter includes at least a code issue parameter, a syntax error parameter, and a security vulnerability parameter, and output the at least one error parameter to the at least one user through the user application interface. That is, the conversion system 108 outputs the translated code files to the user via a user application interface, ensuring that the output is both reliable and informative. This involves a two-step validation process that assesses the quality of the translated code files before they are delivered to the user. Initially, the conversion system 108 validates the plurality of translated code files by identifying error parameters such as code issue parameter, syntax error parameter, and security vulnerability parameter. The code issue parameter highlights potential issues in the logic or structure of the translated code that may affect its functionality or performance, the syntax error parameter highlights any syntax errors that could prevent the code from compiling or executing correctly in the target language, and security vulnerability parameter highlights the potential security risks, such as vulnerabilities. Upon identifying such error parameters, the conversion system 108 outputs the relevant information to the user through the user application interface. This output provides the user with a clear understanding of any issues that may exist within the translated code files, enabling them to address these errors before further integration or deployment.

As described, the system and method disclosed in the present disclosure enables conversion of classic software into the modern software and eliminates the need of high costs and duplicated efforts involved in the conventional methods.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor executable instructions which, when executed by the processor, cause the processor to:
receive an input data from a plurality of data sources, wherein the input data comprises software development artifacts;
preprocess the input data, using a plurality of learning models to determine a file type of the input data;
segment the plurality of preprocessed data into a plurality of data segments based on the determined file type of the input data;
create a plurality of technical design data based on the plurality of data segments, wherein the technical design data corresponds to description of the plurality of data segments in at least one language;
validate the created plurality of technical design data based on one of a prestored rules and a trained artificial intelligence model;
create a plurality of call graph relationship data by establishing a call graph relationship between the plurality of data segments, wherein the establishment of the call graph relationship is based on determined file type of the input data;
create a plurality of summarized technical data by summarizing the created plurality of technical design data and the created plurality of call graph relationship data;
recommend a plurality of languages for translating the code comprised in the plurality of summarized technical data, by analyzing the plurality of summarized technical data;
generate a plurality of translated code file in at least one target language selected by at least one user, by performing the translation of the code comprised in the plurality of summarized technical data into the at least one target language; and
output the plurality of translated code file to the at least one user through a user application interface.

2. The system of claim 1, wherein to determine the file type of the input data, the processor is configured to:
extract a first set of data from the input data, wherein the first set of data corresponds to a subset of the input data;
identify a plurality of file types associated with the first set of data, using a Generative Artificial-Intelligence (GenAI)-based model;
classify the plurality of file types, based on the identified plurality of file types, wherein the plurality of file types comprises at least a Copybook type, a Mapset type, and a Job Control Language (JCL) type; and
determine the file type of the input data, based on the classified plurality of file types.

3. The system of claim 1, wherein to segment the plurality of preprocessed data into the plurality of data segments based on the determined file type of the input data, the processor is configured to:
identify a plurality of logical sections present in the plurality of preprocessed data, based on the determined file type, wherein the plurality of logical sections comprise at least one of a plurality of program divisions and a plurality of functional modules; and
segment the plurality of preprocessed data into the plurality of data segments based on the identified plurality of logical sections.

4. The system of claim 1, wherein to validate the created plurality of technical design data based on one of the prestored rules and the trained artificial intelligence model, the processor is configured to:
map a plurality of key components associated with the generated plurality of technical design data with a plurality of key components associated with the input data; and
validate the plurality of generated technical design data, based on the mapping.

5. The system of claim 1, wherein to create the plurality of call graph relationship data by establishing the call graph relationship between the plurality of data segments, the processor is configured to:
map the plurality of file data segments having a similar file type based on a file type of the plurality of data segments; and
establish the call graph relationship between the plurality of data segments, based on the mapped plurality of data segments, wherein the call graph relationship corresponds to dependencies between the plurality of data segments.

6. The system of claim 1, wherein to recommend the plurality of languages for translating the code comprised in the plurality of summarized technical data, by analyzing the plurality of summarized technical data, the processor is configured to:
determine a plurality of conversion factors for the code comprised in the plurality of summarized technical data, using the Generative Artificial-Intelligence (GenAI)-based model, wherein the plurality of conversion factors comprise at least a syntax compatibility factor, a functionality factor, and a use case factor; and
recommend the plurality of languages for translation of the code comprised in the plurality of summarized technical data, based on the determined conversion factors.

7. The system of claim 1, wherein to generate the plurality of translated code file by performing the translation of the code comprised in the plurality of summarized technical data into at least one target language selected by at least one user, the processor is configured to:
determine whether the at least one target language selected by the at least one user is within the recommended plurality of languages for translation; and
determine a plurality of output efficiency parameters for each of the recommended plurality of languages for translation.

8. The system of claim 7, wherein the processor is further configured to:
create a priority list for the recommended plurality of languages for translation, based on the determined plurality of output efficiency parameters; and
convert the code comprised in the plurality of summarized technical data into a secondary language having a highest priority.

9. The system of claim 1, wherein to output the plurality of translated code file to the at least one user through the user application interface, the processor is configured to:
validate the plurality of translated code file by identifying at least one error parameter associated with the plurality of translated code file, wherein the at least one error parameter comprises at least a code issue parameter, a syntax error parameter, and a security vulnerability parameter; and
output the at least one error parameter to the at least one user through the user application interface.

10. The system of claim 1, wherein to generate the plurality of translated code file, the processor is configured to:
create an automated code and test cases for the received input data based on the created plurality of technical design data.

11. A method comprising:
receiving, by a processor, an input data from a plurality of data sources, wherein the input data comprises software development artifacts;
preprocessing, by the processor, the input data, using a plurality of learning models to determine a file type of the input data;
segmenting, by the processor, the plurality of preprocessed data into a plurality of data segments based on the determined file type of the input data;
creating, by the processor, a plurality of technical design data based on the plurality of data segments, wherein the technical design data corresponds to description of the plurality of data segments in at least one language;
validating, by the processor, the created plurality of technical design data based on one of a prestored rules and a trained artificial intelligence model;
creating, by the processor, a plurality of call graph relationship data by establishing a call graph relationship between the plurality of data segments, wherein the establishment of the call graph relationship is based on determined file type of the input data;
creating, by the processor, a plurality of summarized technical data by summarizing the created plurality of technical design data and the created plurality of call graph relationship data;
recommending, by the processor, a plurality of languages for translating the code comprised in the plurality of summarized technical data, by analyzing the plurality of summarized technical data;
generating, by the processor, a plurality of translated code file in at least one target language selected by at least one user, by performing the translation of the code comprised in the plurality of summarized technical data into the at least one target language; and
outputting, by the processor, the plurality of translated code file to the at least one user through a user application interface.

12. The method of claim 11, wherein determining the file type of the input data comprises:
extracting, by the processor, a first set of data from the input data, wherein the first set of data corresponds to a subset of the input data;
identifying, by the processor, a plurality of file types associated with the first set of data, using the Generative Artificial-Intelligence (GenAI)-based model;
classifying, by the processor, the plurality of file types, based on the identified plurality of file types, wherein the plurality of file types comprises at least a Copybook type, a Mapset type, and a Job Control Language (JCL) type; and
determining, by the processor, the file type of the input data, based on the classified plurality of file types.

13. The method of claim 11, wherein segmenting the plurality of preprocessed data into the plurality of data segments based on the determined file type of the input data, comprises:
identifying, by the processor, a plurality of logical sections present in the plurality of preprocessed data, based on the determined file type, wherein the plurality of logical sections comprise at least one of a plurality of program divisions and a plurality of functional modules; and
segmenting, by the processor, the plurality of preprocessed data into the plurality of data segments based on the identified plurality of logical sections.

14. The method of claim 11, wherein validating the created plurality of technical design data based on one of the prestored rules and the trained artificial intelligence model comprises:
mapping, by the processor, a plurality of key components associated with the generated plurality of technical design data with a plurality of key components associated with the input data; and
validating, by the processor, the plurality of generated technical design data, based on the mapping.

15. The method of claim 11, wherein creating the plurality of call graph relationship data by establishing the call graph relationship between the plurality of data segments comprises:
mapping, by the processor, the plurality of data segments having a similar file type based on a file type of the plurality of data segments; and
establishing, by the processor, the call graph relationship between the plurality of data segments, based on the mapped plurality of data segments, wherein the call graph relationship corresponds to dependencies between the plurality of data segments.

16. The method of claim 11, wherein recommending the plurality of languages for translating the code comprised in the plurality of summarized technical data, by analyzing the plurality of summarized technical data comprises:
determining, by the processor, a plurality of conversion factors for the code comprised in the plurality of summarized technical data, using the Generative Artificial-Intelligence (GenAI)-based model, wherein the plurality of conversion factors comprise at least a syntax compatibility factor, a functionality factor, and a use case factor; and
recommending, by the processor, the plurality of languages for translation of the code comprised in the plurality of summarized technical data, based on the determined conversion factors.

17. The method of claim 11, wherein generating the plurality of translated code file by performing the translation of the code comprised in the plurality of summarized technical data into at least one target language selected by at least one user comprises:
determining, by the processor, whether the at least one target language selected by the at least one user is within the recommended plurality of languages for translation;
and determining, by the processor, a plurality of output efficiency parameters for each of the recommended plurality of languages for translation.

18. The method of claim 17, further comprising:
creating, by the processor, a priority list for the recommended plurality of languages for translation, based on the determined plurality of output efficiency parameters; and
converting, by the processor, the code comprised in the plurality of summarized technical data into a secondary language having a highest priority.

19. The method of claim 11, wherein outputting the plurality of translated code file to the at least one user through the user application interface comprises:
validating, by the processor, the plurality of translated code file by identifying at least one error parameter associated with the plurality of translated code file, wherein the at least one error parameter comprises at least a code issue parameter, a syntax error parameter, and a security vulnerability parameter; and
outputting, by the processor, the at least one error parameter to the at least one user through the user application interface.

20. A non-transitory computer-readable medium comprising machine-readable instructions that are executable by a processor to:
receive an input data from a plurality of data sources, wherein the input data comprises a plurality of stories, epics and features;
preprocess the input data, using a plurality of learning models to determine a file type of the input data;
segment the plurality of preprocessed data into a plurality of data segments based on the determined file type of the input data;
create a plurality of technical design data based on the plurality of data segments, wherein the technical design data corresponds to description of the plurality of data segments in at least one language;
validate the created plurality of technical design data based on one of a prestored rules and a trained artificial intelligence model;
create a plurality of call graph relationship data by establishing a call graph relationship between the plurality of data segments, wherein the establishment of the call graph relationship is based on determined file type of the input data;
create a plurality of summarized technical data by summarizing the created plurality of technical design data and the created plurality of call graph relationship data;
recommend a plurality of languages for translating the code comprised in the plurality of summarized technical data, by analyzing the plurality of summarized technical data;
generate a plurality of translated code file in at least one target language selected by at least one user, by performing the translation of the code comprised in the plurality of summarized technical data into the at least one target language; and
output the plurality of translated code file to the at least one user through a user application interface.
